(19) United States
(12) Patent Application Publication
(10) Pub. No.: US 2018/0365780 A1
(43) Pub. Date: Dec. 20, 2018

(54) SYSTEM AND METHOD FOR INTELLECTUAL PROPERTY INFRINGEMENT DETECTION

(71) Applicant: International Business Machines Corporation, Armonk, NY (US)

(72) Inventors: Harish Bharti, Pune (IN); Sreenath Raghunath, Pune (IN); Sharath Sampath, Bangalore (IN)

(21) Appl. No.: 15/622,795

(22) Filed: Jun. 14, 2017

(51) Int. Cl. G06Q 50/18; G06Q 10/10; G06F 17/27

(52) U.S. Cl. CPC G06Q 50/184; G06F 17/2765; G06Q 10/10

(57) ABSTRACT

The present invention is a system and method for detecting intellectual property infringement. The system comprises a computer processor, which receives a pattern including one or more strings. The pattern can represent an industry taxonomy, a business advantage, or a novelty claim from a patent. The system then assigns a hash value to each string in the pattern and assigns a hash value to each M-character subsequence in an intellectual property database. The intellectual property database includes product data from data sources such as trade fairs, journals, newspapers, case studies, and product press releases. The system then searches for and detects an M-character subsequence with a hash value equal to the hash value of the pattern. Thereafter, the pattern is compared to the M-character subsequence by character until unmatching characters are found. Finally, for each matching pattern, a notification is transmitted indicating a potential infringement match has been found.

### BACKGROUND

The present invention relates generally to intellectual property infringement detection, and more particularly to a network for detecting and monitoring patent infringement.

One of the problems that plague businesses and other organizations is getting their enterprise to become innovative. While “innovation” has been and will continue to be described in many ways and contexts, the end goal is to create value and protect the value for an organization. The environment today offers “patenting” as a method of creating value and protecting unique ideas in the form of “intellectual property.”

Today, intellectual property (IP) is a common and well-used phrase in almost all industries and technologies across the globe. Every organization races toward collecting its intellectual property and potentially looks at making revenue as well as offering IP to customers apart from “home use.”

Most organizations have their own methods to create, monitor, evaluate, and file inventions. While home grown methods exist, a structured and re-usable method/framework is missing.

Raising an organization to become a leader in IP is a rather arduous task and requires a structure, governance, and participation of employees, as well as dedicated teams, to push the initiative. In spite of being a market leader in intellectual property, if we are not able to detect infringements, it is a direct loss of revenue as well as a loss of opportunities to make an impact.

There is patent analysis technology in use today, but the available technology is related to patentability and a right-to-use analysis. Current systems and methods only have the capability to analyze issued patents, published applications, and other publications and search for specific terms. Further, many of these systems rely on Boolean-based text searching. The information is useful for a patentability analysis involving novelty and nonobviousness, or a right-to-use analysis based on issued patents, which both provide information to inventors or entities prior to entering the marketplace. However, these systems do not cover infringement monitoring and detection for the entities already in possession of protected intellectual property.

Therefore, there is a need for a system ad method for intelligent, efficient, scalable, and accurate intellectual property infringement monitoring and detection.

### SUMMARY

The present invention is a system and method for intellectual property infringement detection. The system includes a computer processor having a non-transitory memory containing program code for: receiving a pattern comprising one or more strings, assigning a first hash value to each string in the pattern, assigning a second hash value to each M-character subsequence in an intellectual property database, detecting an M-character subsequence, wherein the second hash value of the M-character subsequence is equal to the first hash value, and comparing the pattern to the M-character subsequence by character until unmatching characters are found.

In an alternative embodiment, the system is a computer program product providing intellectual property infringement detection. The computer program comprises a computer readable storage medium having program instructions embodied therewith. The computer readable storage medium is not a transitory signal per se. The program instructions are readable by a computer to cause the computer to perform a method comprising the steps of: receiving a pattern representing patent information, the pattern comprising one or more strings, assigning a first hash value to each string in the pattern, assigning a second hash value to each M-character subsequence in an intellectual property database, detecting an M-character subsequence, wherein the second hash value of the M-character subsequence is equal to the first hash value, and comparing the pattern to the M-character subsequence by character until unmatching characters are found.

In another embodiment, the method for detecting intellectual property infringement, includes the steps of: providing a patent, extracting an industry taxonomy from the patent, calculating a first hash value for the industry taxonomy of the patent, calculating a second hash value for each M-character subsequence in an intellectual property database, detecting an M-character subsequence, wherein the second hash value of the M-character subsequence is equal to the first hash value, comparing the industry taxonomy to the M-character subsequence by character until unmatching characters are found, extracting a business advantage from the patent, calculating a third hash value for the business advantage of the patent, calculating a fourth hash value for each M-character subsequence in an intellectual property database, detecting an M-character subsequence, wherein the fourth hash value of the M-character subsequence is equal to the third hash value, and comparing the business advantage to the M-character subsequence by character until unmatching characters are found.

### BRIEF DESCRIPTION OF THE DRAWINGS

The present invention will be more fully understood and appreciated by reading the following Detailed Description in conjunction with the accompanying drawings, in which:

FIG. 1 is a conceptual diagram of a non-limiting illustrative embodiment of the system for detecting intellectual property infringement;

FIG. 2 is a flowchart of a non-limiting illustrative embodiment of a method of detecting potential infringement;

FIG. 3 is an additional conceptual diagram of a non-limiting illustrative embodiment of a feed collection module of the system;

FIG. 4 is a flowchart of non-limiting illustrative embodiment of a method for notifying a user of a potential infringement;

FIG. 5 is a flowchart of a non-limiting illustrative embodiment of the system workflow;

FIG. 6 is a continuation of the flowchart of FIG. 5 of a non-limiting illustrative embodiment of the system workflow;

FIG. 7 is a continuation of the flowchart of FIG. 6 of a non-limiting illustrative embodiment of the system workflow; and

FIG. 8 is a diagram of a non-limiting illustrative embodiment of a patent context model for a patent;

FIG. 9 is a diagram of non-limiting illustrative embodiment of ongoing searching and match-making for a patent.

### DETAILED DESCRIPTION

Referring to the Figures, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

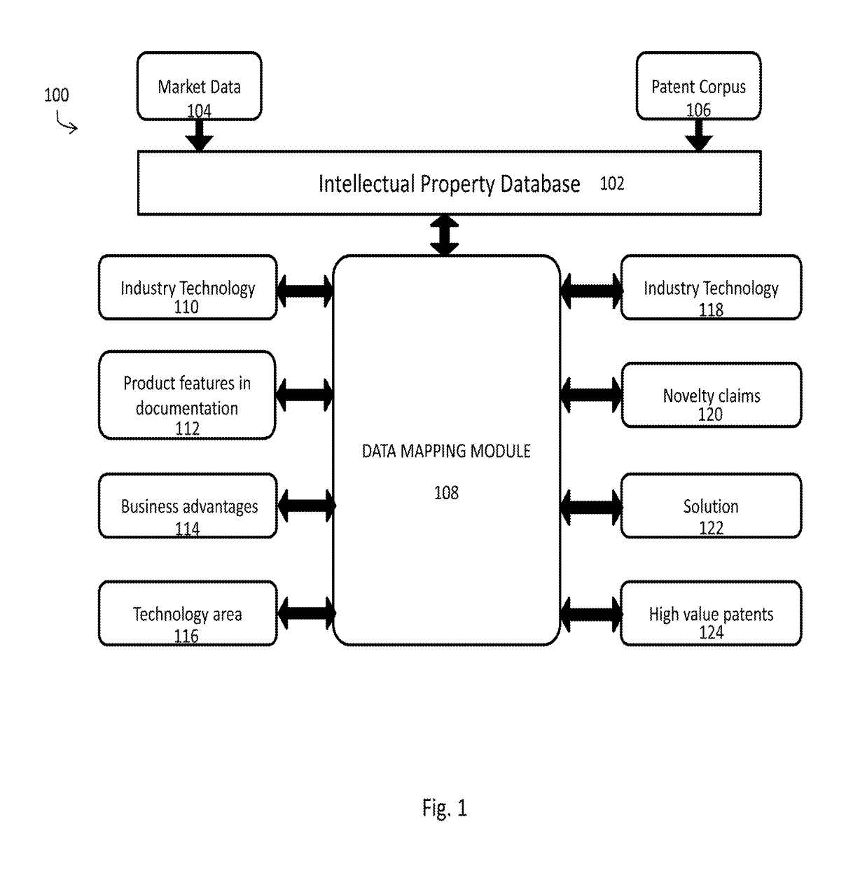

Referring again to the drawings, wherein like reference numerals refer to like parts throughout, there is seen in FIG. 1 a conceptual diagram of a non-limiting illustrative embodiment of the system 100 for detecting intellectual property infringement. The system 100 is a computer system comprising an intellectual property database 102. The intellectual property database 102 is frequently receiving information in the form of market data 104 and text-based patent data, i.e. a patent corpus 106. The market data 104 comprises, for example, data from trade fairs, journals, newspapers, case studies, and other relevant sources on new product launches and version releases. The market data 104 may also include any hype and trend information from a particular technical field. The patent corpus 106 comprises domestic and foreign patent references, such as published patent applications and issued patents. Data related to the patent references, such as the technological field, the implementation area, invention features, the solution to be solved by the invention, the business advantages of the invention, known problems confronted by the invention or remaining to be solved in the field of art is also included in the patent corpus.

Still referring to FIG. 1, the system further comprises a data mapping module 108. The data mapping module 108, via a processor, creates data mappings using the market data 104 and the patent corpus 106. Through data mapping, connections are made between market data 104, such as related industry technology 110, product features in documentation 112, business advantages 114, and the technology area 116, and patent corpus data, such as the related industry technology 118, novelty claims 120, the solution to the industry problem 122, and high value patents 124. Patents are labeled “high value” if they have a higher business impact. The system 100 creates initial data mappings, which are then updated with new information in journals, newly published patent applications, newspapers, and other sources as they publish or otherwise become publicly available.

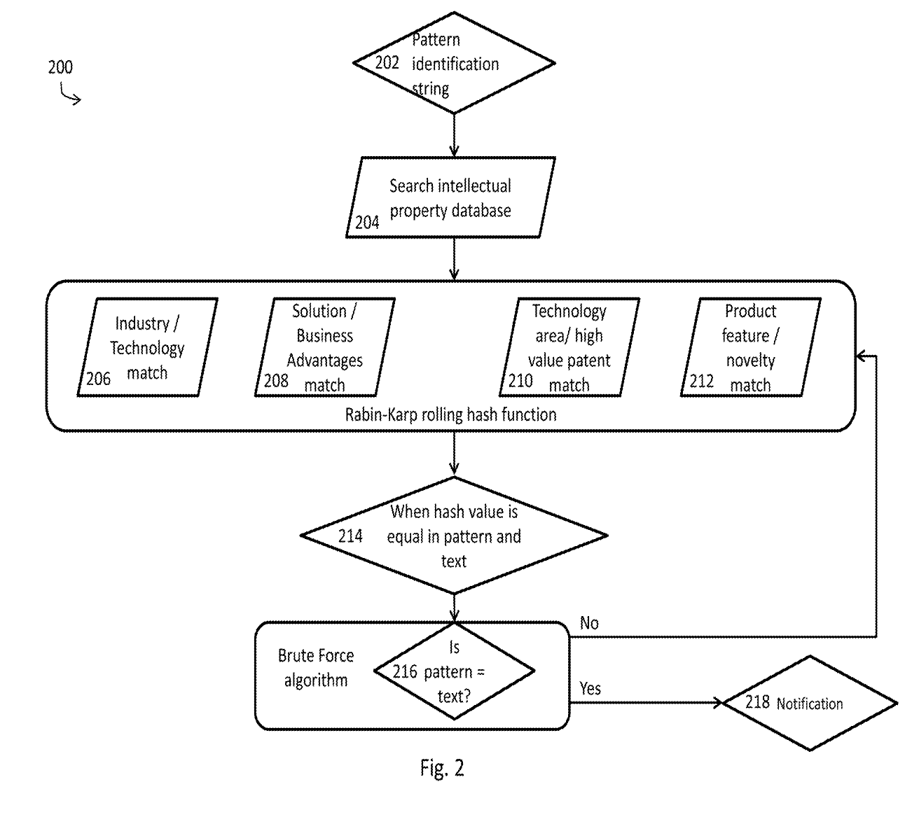

Referring now to FIG. 2, there is shown a flowchart of a non-limiting illustrative embodiment of a method 200 of detecting potential infringement. The system 100 in FIG. 1 can be utilized to detect potential infringement of a patent or otherwise protected intellectual property. Before the system 100 can search for potential infringement, the system 100 must receive a pattern that will become the basis of the search. The pattern is extracted from a patent in the patent corpus 106. As will be described below, the pattern can be an industry taxonomy, a business advantage, or a novelty claim.

At the first step 202 for detecting potential infringement, the pattern is reduced to a pattern identification string. To accomplish this, the system 100 can use the Rabin-Karp string searching algorithm that utilizes a hash function to speed up the search. The Rabin-Karp algorithm focuses on reducing the time for comparison by calculating hash of strings and hash of relevant substrings. The Rabin-Karp string searching algorithm calculates a hash value for the pattern, and for each M-character subsequence of text to be compared. The text to be compared is any of text of the data stored in the intellectual property database 102. At step 204, the intellectual property database 102 is searched. As shown in the embodiment in FIG. 2, the system 100 can search similar industry or technology areas 206, solutions and business advantages 208, technology area and high value patents 210, and product features and novelty claims 212, for example.

The Rabin-Karp algorithm is used to perform the searches for a pattern that is M characters long, as follows:
hash_p=hash value of pattern
hash_t=hash value of first M letter in
body of text
do
if (hash_p==hash_t)
brute force comparison of pattern
and selected section of text
hash_t=hash value of next section of
text, one character over
while (end of text or
brute force comparison==true)
   The decision making model is as follows:
h(i)=((t[i]×bM-1 mod q)+
(t[i+1]×bM-2 mod q)++
(t[i+M-1] mod q)) mod q
h(i+1)=(h(i)×b mod q Shift left one digit
−t[i]×bM mod q Subtract leftmost digit
+t[i+M] mod q Add new rightmost digit
mod q

If the hash value for the pattern and the first M-character subsequence of text are unequal, the algorithm will calculate the hash value for next M-character sequence. If the hash values are equal at step 214, the algorithm will do a Brute Force comparison between the pattern and the M-character sequence at step 216. In this way, there is only one comparison per text subsequence, and Brute Force is only needed when hash values match.

Still referring to FIG. 2, the system 100 only introduces the Brute Force algorithm at step 216 once the hash value of the pattern matches the text. The Brute Force algorithm compares the pattern to the text, one character at a time, until unmatching characters are found. The algorithm can be designed to stop on either the first occurrence of the pattern, or upon reaching the end of the text. The Brute Force algorithm can be executed as follows:
do
if (text letter==pattern letter)
compare next letter of pattern to next
letter of text
else
move pattern down text by one letter
while (entire pattern found or end of text)

The above is given a pattern M-characters in length, and a text N-characters in length. The total number of comparisons and worst case time complexity is calculated as shown below.

Total number of comparisons=M(N−M+1)

Worst case time complexity=O(MN)

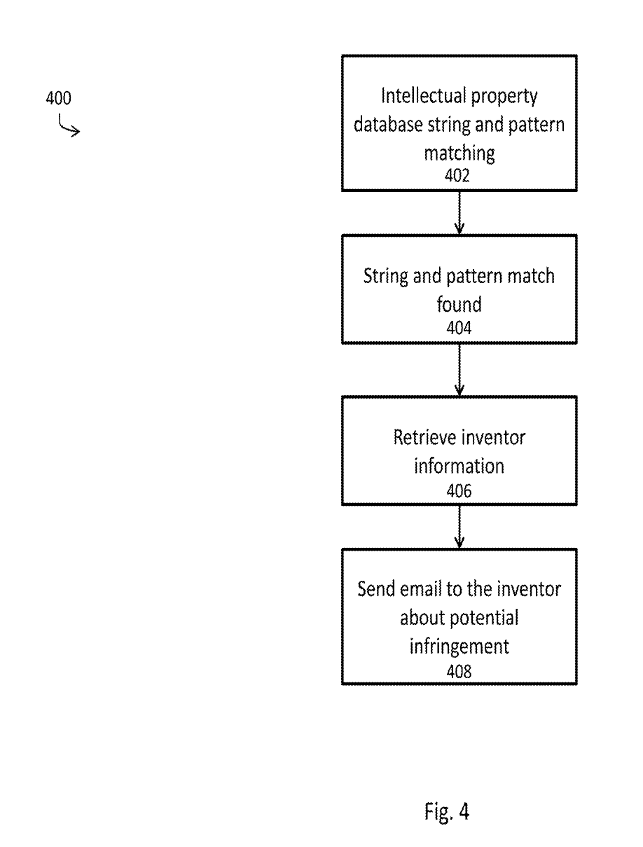

The last step 218 of the method is to send a notification of the potential infringement detection. Referring briefly to FIG. 4, there is shown a flowchart of non-limiting illustrative embodiment of a method 400 for notifying a user of a potential infringement. As stated above, the system 100 performs step 402 of intellectual property database string and pattern matching until a string and pattern match is found at step 404. At the next step 406, the system retrieves inventor information. The system retrieves inventor information from the patent corpus. The system then sends a notification to the inventor alerting the inventor of the potential infringement at step 408. Thus, the system sends a notification for each matching pattern found. In one embodiment, the notification is an email; however, other notifications such as automated phone calls and text messages, for example, can be utilized.

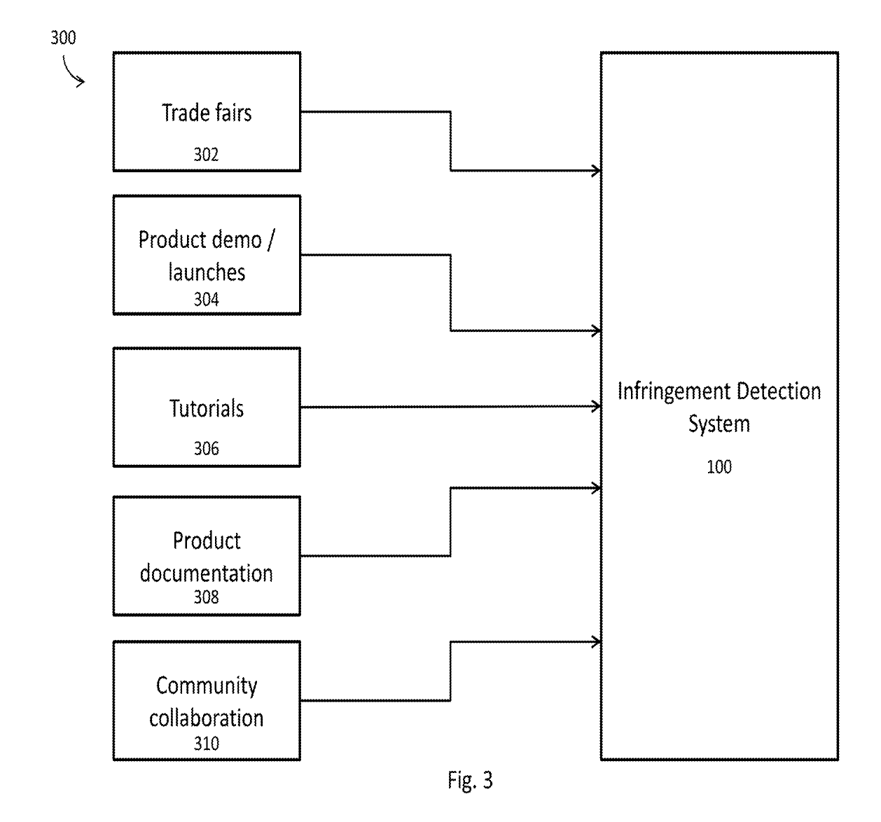

Referring now to FIG. 3, there is shown a diagram of a non-limiting illustrative embodiment of a feed collection module 300 of the system 100. FIG. 3 shows exemplary sources of data with text that can be searched by the system 100. The system 100 uses the feed collection module 300 to continuously ingest data by providing a link to monitor infringement. The system 100 is thus always updated with information and data from trade fairs 302, product demonstrations and launches 304, tutorials 306, product documentation 308, and community collaboration 310. Most of the data can be extracted from journals, publications and other sources available online, such as press releases detailing product launches or trade fair websites listing the vendors and vendor products, for example. Regarding community collaboration, the system may comprise an input mechanism for users to upload or otherwise add information and data about emerging technologies and products.

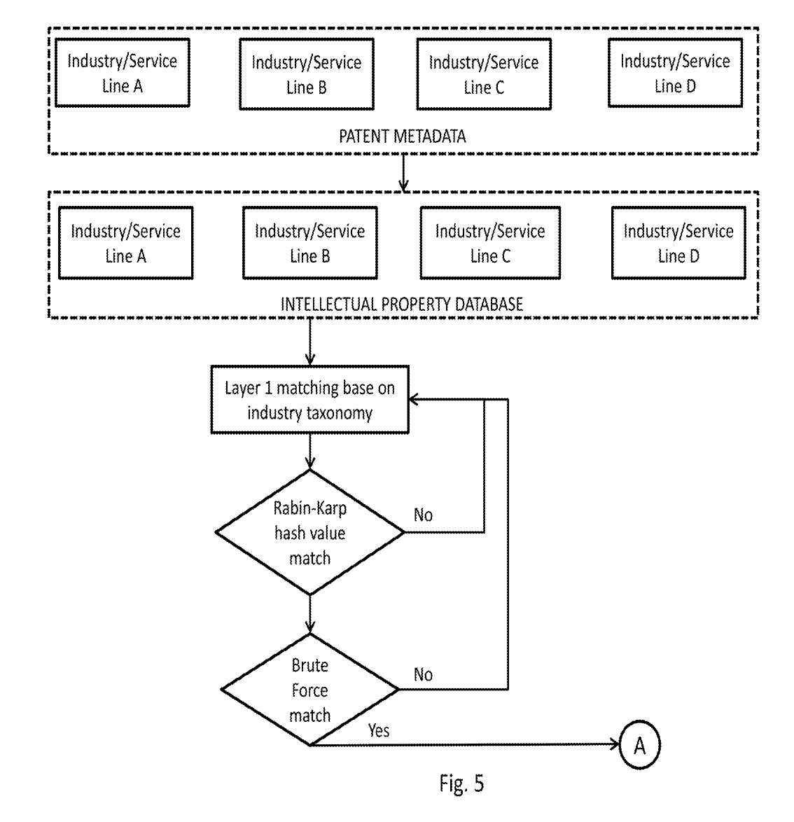

Referring now to FIGS. 5-7, there are shown flowcharts of the system workflow for the method of detecting intellectual property infringement. In the embodiment depicted in FIG. 5, there is patent metadata describing various industries and services. The patent metadata is transmitted and received by the intellectual property database. The system then conducts a first layer of matching according to the method shown in FIG. 2. The system first applies the Rabin-Karp algorithm by assigning a hash value to the pattern and for each M-subsequence of text to be compared. If the hash values are equal, a Brute Force comparison between the pattern and the M-character subsequence is conducted. In the depicted embodiment, the first layer of matching is based on industry taxonomy. Thus, a Brute Force match would occur when the text represents the same or highly similar industry taxonomy as the pattern represents. A search based solely on industry taxonomy would likely yield numerous results, which would require further filtering through additional layers of matching.

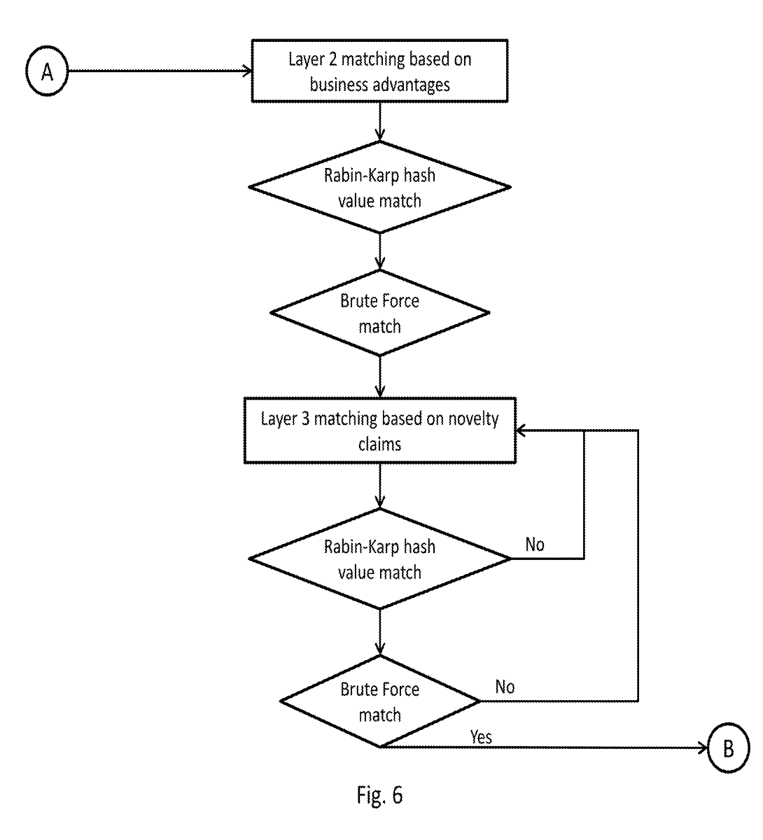

Referring now to FIG. 6, the system conducts a second layer of matching based on business advantages. Again, the system follows the method shown in FIG. 2, applying the Rabin-Karp algorithm and conducting a Brute Force comparison. To further narrow the search results, the system conducts a third layer of matching based on novelty claims. Using the Rabin-Karp algorithm and the Brute Force comparison, matches at this layer are candidates for potential infringement because the language of the claims of the patent is similar to the text and due to the matching in the previous layers, the text is known to be in the same industry providing the same or similar business advantages.

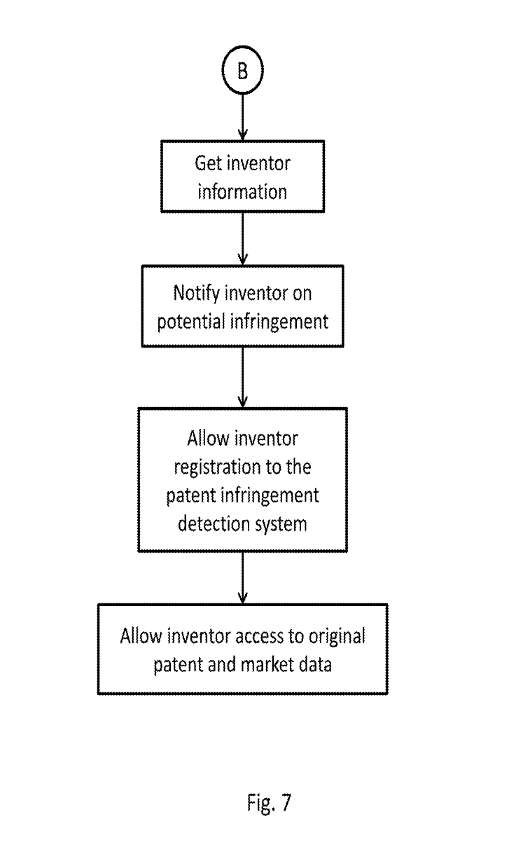

Referring now to FIG. 7, once text matching at all three layers is discovered, the system retrieves inventor information. As stated above, such information can be submitted by the user, extracted from the patent when added to the system, or extracted from online sources. The system transmits a notification to the inventor regarding the potential infringement via email, automated phone call, text message, or any other known notification and messaging system. The inventor can be provided access to the system through a registration process. Such process can occur at a user interface on a user's personal computer, smartphone, or other computing device. With access to the system, the inventor can retrieve the original patent data and market data with the potential infringement information.

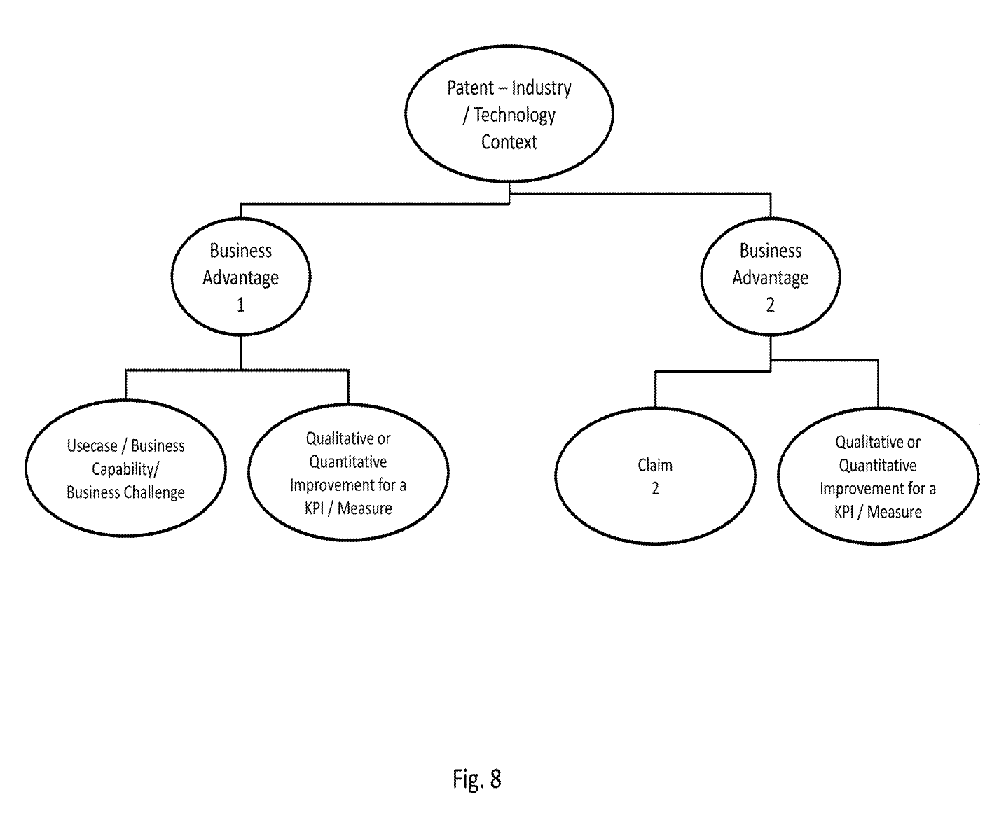

Referring now to FIG. 8, there is shown a diagram of a non-limiting illustrative embodiment of a patent context model for a patent. The system continues to execute searches according to method shown in FIG. 2 and the workflow shown in FIGS. 5-7 to create a patent context model for each patent. In the depicted diagram, the patent is first classified by the industry or technology taxonomy. For many patents, there is often more than one business advantage. Therefore, the system conducts a search using each business advantage as a matching layer. Similarly, each patent often contains more than one novelty claim. Each claim may also be associated with one or more business advantages. A tree-like diagram can be created, as shown in FIG. 8, detailing the connections between business advantages and claims of a single patent and generating context for the patent. Thus, the system can conduct layers of matching according to connections in the tree diagram.

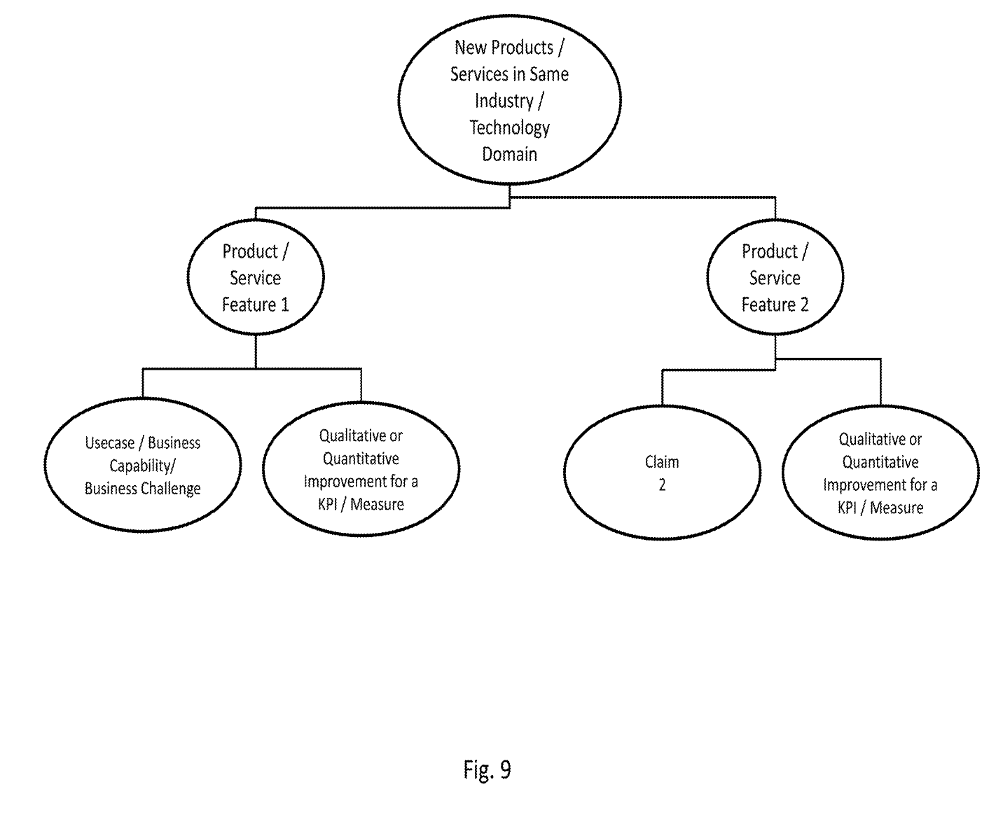

Referring now to FIG. 9, there is shown a diagram of non-limiting illustrative embodiment of ongoing searching and match-making for a patent. As new products are announced and documented, the system updates its match-making based on the new data. As shown in the depicted diagram, when the system receives data regarding a new product or service in the same industry or technology domain as a patent, it defines features comprising the product or service. Then, for each feature, the system creates a patent context model based on business advantages and claims, as shown in FIG. 8. Thus, the system continues to receive new information and adapt, which allows for continuous infringement monitoring.

While embodiments of the present invention has been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements.

What is claimed is:

1. A computer processing system for identifying potential patent infringement, comprising:
a computer processor having a non-transitory memory containing program code for:
receiving a pattern comprising one or more strings;
assigning a first hash value to each string in the pattern;
assigning a second hash value to each M-character subsequence in an intellectual property database;
detecting an M-character subsequence, wherein the second hash value of the M-character subsequence is equal to the first hash value; and
comparing the pattern to the M-character subsequence by character until unmatching characters are found.

2. The system of claim 1, wherein the pattern is an industry taxonomy.

3. The system of claim 1, wherein the pattern is a business advantage.

4. The system of claim 1, wherein the pattern is a novelty claim.

5. The system of claim 1, wherein the intellectual property database comprises data from at least one of trade fairs, journals, newspapers, case studies, and product press releases.

6. The system of claim 1, further comprising program code for retrieving contact information for an inventor.

7. The system of claim 1, further comprising program code for transmitting a notification of potential infringement.

8. A computer program product providing intellectual property infringement detection, the computer program comprising a computer readable storage medium having program instructions embodied therewith, wherein the computer readable storage medium is not a transitory signal per se, the program instructions are readable by a computer to cause the computer to perform a method comprising the steps of:
receiving a pattern representing patent information, the pattern comprising one or more strings;
assigning a first hash value to each string in the pattern;
assigning a second hash value to each M-character subsequence in an intellectual property database;
detecting an M-character subsequence, wherein the second hash value of the M-character subsequence is equal to the first hash value; and
comparing the pattern to the M-character subsequence by character until unmatching characters are found.

9. The method of claim 8, wherein the patent information is at least one of an industry taxonomy, a business advantage, and a novelty claim.

10. The method of claim 8, further comprising the steps of:
retrieving contact information for an inventor; and
transmitting a notification to the inventor indicating potential infringement.

11. The method of claim 8, further comprising the step of receiving, at the intellectual property database, data representing a new product.

12. The method of claim 11, further comprising the step of determining features of the new product.

13. The method of claim 8, further comprising the step of receiving, at the intellectual property database, at least one of market data and patent data from online publications.

14. A method for detecting intellectual property infringement, comprising the steps of:
providing a patent;
extracting an industry taxonomy from the patent;
calculating a first hash value for the industry taxonomy of the patent;
calculating a second hash value for each M-character subsequence in an intellectual property database;
detecting an M-character subsequence, wherein the second hash value of the M-character subsequence is equal to the first hash value;
comparing the industry taxonomy to the M-character subsequence by character until unmatching characters are found;
extracting a business advantage from the patent;
calculating a third hash value for the business advantage of the patent;
calculating a fourth hash value for each M-character subsequence in an intellectual property database;
detecting an M-character subsequence, wherein the fourth hash value of the M-character subsequence is equal to the third hash value; and
comparing the business advantage to the M-character subsequence by character until unmatching characters are found.

15. The method of claim 14, further comprising the steps of:
calculating a fifth hash value for the novelty claim of the patent;
calculating a sixth hash value for each M-character subsequence in an intellectual property database;
detecting an M-character subsequence, wherein the sixth hash value of the M-character subsequence is equal to the fifth hash value; and
comparing the novelty claim to the M-character subsequence by character until unmatching characters are found.

16. The method of claim 15, further comprising the step of transmitting a notification of potential infringement.

17. The method of claim 14, wherein the patent is a high value patent.

18. The method of claim 15, further comprising the steps of:
receiving new product data; and
updating the intellectual property database with the new product data.

19. The method of claim 14, wherein the intellectual property database comprises data representing at least one of a technology field, a product feature, a solution, a business advantage, a known problem, and a technology trend.

20. The method of claim 14, further comprising the step of creating a data map with market data and patent data from the intellectual property database.
